(19) United States
(12) Patent Application Publication
(10) Pub. No.: US 2024/0320484 A1
(43) Pub. Date: Sep. 26, 2024

(54) SYSTEM AND METHOD FOR ONE-SHOT NEURAL ARCHITECTURE SEARCH WITH SELECTIVE TRAINING

(71) Applicant: WOVEN BY TOYOTA, INC., Tokyo (JP)

(72) Inventor: Koichiro YAMAGUCHI, Tokyo (JP)

(73) Assignee: WOVEN BY TOYOTA, INC., Tokyo (JP)

(21) Appl. No.: 18/189,728

(22) Filed: Mar. 24, 2023

(51) Int. Cl. G06N 3/08; G06N 3/045

(52) U.S. Cl. CPC G06N 3/08; G06N 3/045

(57) ABSTRACT

A method for performing a one-shot neural architecture search (NAS) includes obtaining an overall network, the overall network including a plurality of candidate subnetworks for the one-shot NAS, obtaining a first subnetwork of the plurality of candidate subnetworks from the overall network, obtaining a first metric value of the first subnetwork, determining whether the first metric value satisfies a first predetermined condition, based on determining that the first metric value does not satisfy the first predetermined condition, determining not to train the obtained first subnetwork for the one-shot NAS and obtaining a second subnetwork of the plurality of candidate subnetworks from the overall network, and training the second subnetwork for the one-shot NAS.

### 1. FIELD

Apparatuses and methods consistent with example embodiments of the present disclosure relate to neural architecture search (NAS).

### 2. DESCRIPTION OF RELATED ART

In general, a neural network may be characterized by two main parameters: (1) the architecture; and (2) the weights applied to inputs transmitted between neurons. Typically, the architecture is manually or hand-designed, while the weights are optimized by training the network with a training set and neural network algorithm. Thus, to optimize performance of the neural network, the architecture design is an important consideration, particularly as it is generally static once the network is deployed for use.

In the related art, neural architecture search (NAS) has emerged as a technique for automatically designing the architecture of a neural network. However, the process is extremely time-consuming and sensitive to the initial state (i.e., the initial sample architecture) due to the iterative nature.

### SUMMARY

According to embodiments, systems and methods are an optimized one-shot neural architecture search (NAS) in which some evaluation is performed in an overall network one-shot training phase to eliminate unnecessary or negatively impacting training iterations (i.e., subnetworks that negatively impact the overall training).

According to an aspect of the disclosure, a method for performing a one-shot NAS may include obtaining an overall network, the overall network including a plurality of candidate subnetworks for the one-shot NAS, obtaining a first subnetwork of the plurality of candidate subnetworks from the overall network, obtaining a first metric value of the first subnetwork, determining whether the first metric value satisfies a first predetermined condition, based on determining that the first metric value does not satisfy the first predetermined condition, determining not to train the obtained first subnetwork for the one-shot NAS and obtaining a second subnetwork of the plurality of candidate subnetworks from the overall network, and training the second subnetwork for the one-shot NAS.

According to an aspect of the disclosure, a system for performing a one-shot NAS may include at least one memory storing instructions, and at least one processor configured to execute the instructions to obtain an overall network, the overall network including a plurality of candidate subnetworks for the one-shot NAS, obtain a first subnetwork of the plurality of candidate subnetworks from the overall network, obtain a first metric value of the first subnetwork, determine whether the first metric value satisfies a first predetermined condition, based on determining that the first metric value does not satisfy the first predetermined condition, determine not to train the obtained first subnetwork for the one-shot NAS and obtain a second subnetwork of the plurality of candidate subnetworks from the overall network, and train the second subnetwork for the one-shot NAS.

According to an aspect of the disclosure, a non-transitory computer-readable storage medium may store instructions that, when executed by at least one processor, cause the at least one processor to obtain an overall network, the overall network including a plurality of candidate subnetworks for the one-shot NAS, obtain a first subnetwork of the plurality of candidate subnetworks from the overall network, obtain a first metric value of the first subnetwork, determine whether the first metric value satisfies a first predetermined condition, based on determining that the first metric value does not satisfy the first predetermined condition, determine not to train the obtained first subnetwork for the one-shot NAS and obtain a second subnetwork of the plurality of candidate subnetworks from the overall network, and train the second subnetwork for the one-shot NAS.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 is a diagram of a neural network architecture according to an embodiment;

FIG. 2 is a diagram of an example of a neural architecture search (NAS) being performed according to an embodiment;

FIG. 3 is a diagram of a single path one-shot (SPOS) method, according to an embodiment;

FIG. 4 is a diagram of SPOS subnetworks, according to an embodiment;

FIG. 5 is a flowchart of a method of a NAS, according to an embodiment;

FIG. 6 is a diagram of an example environment in which systems and/or methods, described herein, may be implemented; and

FIG. 7 is a diagram of example components of a device according to an embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide a method and system in which the system may obtain an overall network, the overall network including a plurality of candidate subnetworks for the NAS, obtain a first subnetwork of the plurality of candidate subnetworks from the overall network, obtain a first metric value of the first subnetwork, determine whether the first metric value satisfies a first predetermined condition, based on determining that the first metric value does not satisfy the first predetermined condition, determine not to train the obtained first subnetwork for the one-shot NAS and obtain a second subnetwork of the plurality of candidate subnetworks from the overall network. The system may train the second subnetwork for the one-shot NAS. By filtering out impossible or impractical subnetworks in the training stage of the one-shot NAS, potentially detrimental and unnecessary training may be omitted, thereby avoiding redundant training and collapse of shared weights, and expediting the training stage.

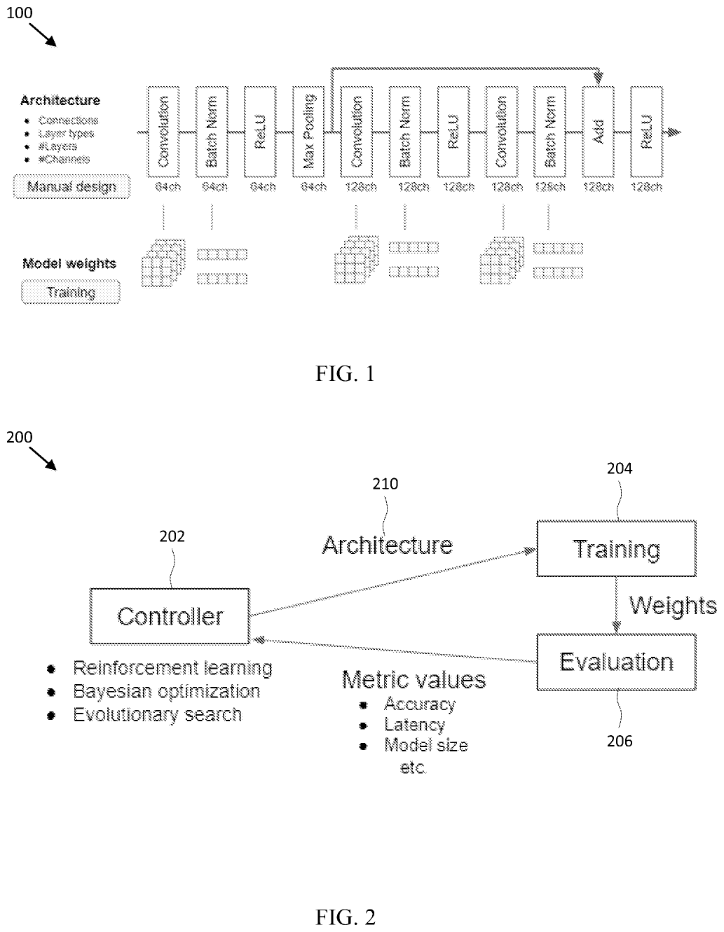

FIG. 1 is a diagram of a neural network architecture according to an embodiment. Referring to FIG. 1, the neural network architecture 100 is defined by its connections, layer types (or operations), number of layers, and the number of channels in each layer. The layer types include, for example, convolutional (in the case of a convolutional neural network (CNN)), activation (e.g., rectified linear unit (ReLU)), pooling (Max Pooling), fully connected, batch normalization (Batch Norm), dropout, etc. The architectural design of a network is embodied by a combination of layers corresponding to at least some of these layer types.

FIG. 2 is a diagram of an example of a neural architecture search (NAS) being performed according to an embodiment. NAS may refer to a technique for automatically designing an architecture of a neural network. The functional block diagram 200 is shown in FIG. 2 of an NAS being performed in accordance with a sampling method or algorithm (e.g., reinforcement learning, evolutionary search, Bayesian optimization, etc.). The NAS may be implemented with a controller 202, as well as a training operation 204 and an evaluation operation 206.

Referring to FIG. 2, the sampling method may be an iterative process by which a controller 202 generates a sample architecture candidate 210 (e.g., from a search space of a set of layers). The sample architecture 210 may be optimized via the training operation 204 and the evaluation operation 206 to obtain metric values, such as accuracy, latency, model size, etc. Based on the evaluation results of the evaluation operation 206 of the previous sample, the controller 202 may generate a next sample architecture candidate using methods such as reinforcement learning, Bayesian optimization, an evolutionary algorithm, etc. This process may be repeated performed until a target performance is reached (e.g., until a target accuracy is obtained, a target latency is obtained, a target model size is obtained, etc.).

While the sampling method shown in FIG. 2 may be flexible in terms of network structures (i.e., in terms of layer types, number of channels, number of layers, macro architecture, etc.) and may provide a trained model with a known performance (i.e., no need for re-training), the process is extremely time-consuming and sensitive to the initial state (i.e., the initial sample architecture) due to its iterative nature. That is, the sampling method requires many iterations to train, evaluate, and update/mutate the sample architecture (particularly where the initial seed(s) are suboptimal) in order to eventually obtain an optimal architecture.

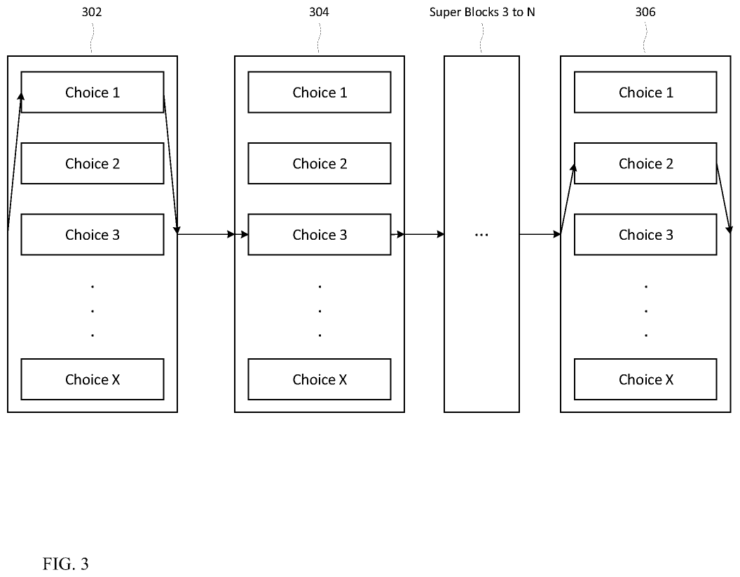

FIG. 3 is a diagram of a single path one-shot (SPOS) method, according to an embodiment. A one-shot NAS method may reduce computation overhead and time for the search, by decoupling the training from the evaluation and search, and performing the training on an overall network that includes of all candidate network architectures in a defined search space (e.g., referred to herein as SuperNet). That is, the overall network may include a plurality of candidate subnetworks for the NAS. In particular, an SPOS method may train a single subnetwork of the SuperNet in each iteration, and apply the resulting weights uniformly on all underlying architectures.

Referring to FIG. 3, the SPOS method may include a number of super blocks, such as super block 302, super block 304, up to super block N 306. Each superblock may include a plurality of choice blocks. The SPOS method may randomly select a single path connecting choice blocks in a plurality of successive super blocks (as shown by, for example, the arrows in FIG. 3), with each super block corresponding to one layer (and/or one set of layers) and each choice block corresponding to a candidate layer (and/or sets of layers). For example, in the super blocks 302-306, choice 1 may be a 3×3 CNN, choice 2 may be a 5×5 CNN, choice 3 may be a ReLU, up to choice X, etc. This process may be repeated, with the weight applied for a choice block in one training iteration uniformly applied to that choice block in another iteration including that choice block is included in the chosen path (i.e., a subnetwork). That is, the weights determined during a training iteration are shared across architecture candidates (i.e., subnetworks). A sampling method (e.g., evolutionary algorithm) may be then applied to efficiently search for the best-performing architecture(s) without any fine tuning. By decoupling the training from the evaluation and search, only a single training is needed and different constraints may be applied after training.

In example embodiments where the search space or SuperNet is large and any subnetwork may be selected, the training becomes more difficult, complex, and time-consuming. In such cases, it may be difficult to further train the SuperNet sufficiently.

Example embodiments may include optimized one-shot neural architecture search (NAS) in which some evaluation is performed in the overall network (e.g., the SuperNet) one-shot training phase to eliminate unnecessary or negatively impacting training iterations (i.e., subnetworks that negatively impact the overall training).

In example embodiments, certain architecture metrics may be evaluated without training. Accordingly, these evaluations are performed during the training phase. For example, metrics such as model size, floating point operations per second (FLOPS) value, latency, etc., may be assessed with respect to a subnetwork prior to training that subnetwork and the metrics may not be impacted by the training. Thus, if a randomly-selected subnetwork during an iteration of the SPOS training has one or more metrics that do not satisfy particular criteria (e.g., a model size that is less than a first threshold or greater than a second threshold, a latency greater than a third threshold, etc.), that subnetwork is not trained (i.e., the subnetwork is rejected) and another subnetwork may be selected (e.g., selected at random or selected based on a predetermined order of subnetworks). As a result, unnecessary or potentially detrimental training iterations are avoided, redundant training and collapse of shared weights are avoided, and the overall training time is reduced.

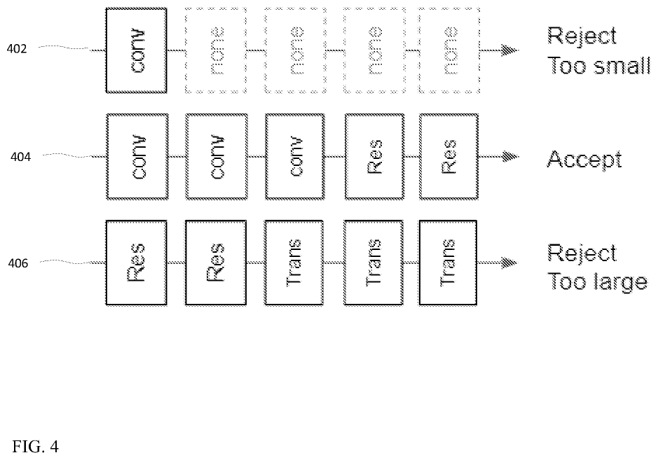

FIG. 4 is a diagram of SPOS subnetworks, according to an embodiment. That is, FIG. 4 illustrates examples of randomly selected or constructed subnetworks for the SPOS search, such as subnetwork 402, subnetwork 404, and subnetwork 406.

As shown in FIG. 1, subnetwork 402 is determined to be smaller than a first threshold and therefore rejected without training. The first threshold may be a threshold determined based on the number of layers or components of a subnetwork. The thresholds may be based on an overall number of layers in the subnetwork, an overall number of convolutional layers in the subnetwork, an overall number of residual blocks in the networks, an overall number of transport layers, etc. As a result, an unnecessary or potentially detrimental training is avoided. Further, collapse of shared weights is avoided. That is, subnetwork 402 (i.e., a single convolutional layer architecture) is an impossible network architecture. If the subnetwork 402 were trained in the SPOS search, the resulting shared weight for that convolutional layer choice block of the first superblock would be suboptimal for any realistic or possible network architecture including said layer. In this case, then, additional training iterations would be required to obtain an optimal weight of that choice block. By rejecting the subnetwork 402 without training it, redundant or unnecessary training is avoided, and the overall training becomes faster.

Additionally, subnetwork 404 may be determined to be acceptable, whereas subnetwork 406 may be determined to be unacceptable as being too large, and an unnecessary or potentially detrimental training is avoided.

In addition, a method of determining a final architecture for a task neural network for performing a target machine learning task is provided. The target machine learning task may be associated with a target training dataset. The system may generate a target meta-features tensor for the target training dataset, where the target meta-features tensor represents features of the target training dataset, repeatedly perform: generating, from a search space defining multiple architectures, a candidate architecture for the task neural network for performing the target machine learning task, and processing an input comprising the target meta-features tensor and data specifying the candidate architecture based on an evaluator neural network to generate a candidate performance score that estimates a performance of the candidate architecture on the target machine learning task. The system may identify, as the final architecture, a candidate architecture that has a maximum candidate performance score among the candidate architectures.

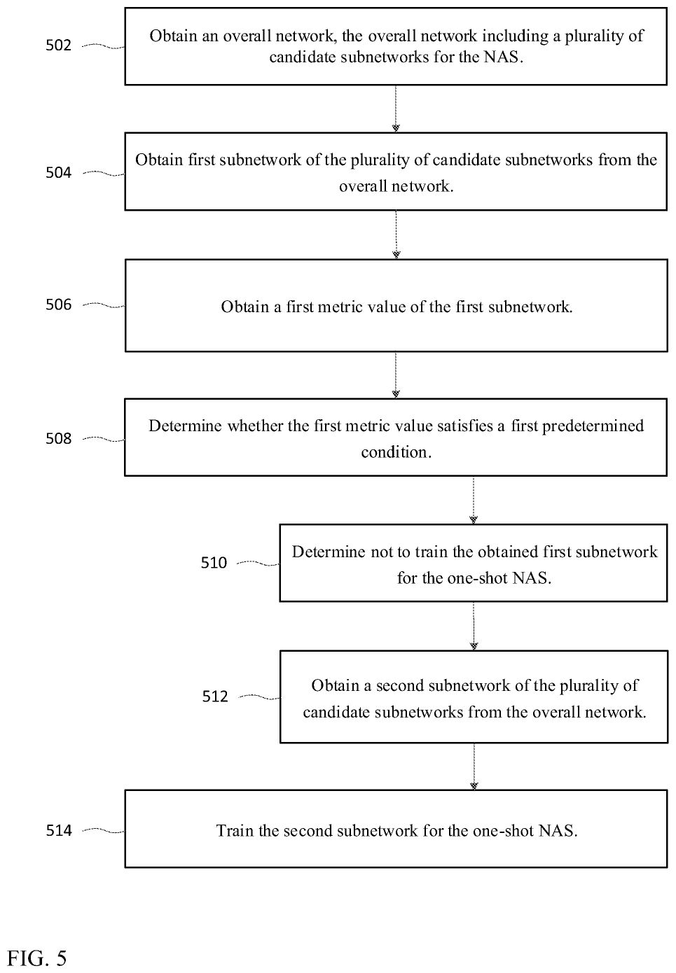

FIG. 5 is a flowchart of a method of a NAS, according to an embodiment. In operation 502, the system may obtain an overall network, the overall network including a plurality of candidate subnetworks for the NAS. In operation 504, the system may obtain a first subnetwork of the plurality of candidate subnetworks from the overall network. In operation 506, the system may obtain a first metric value of the first subnetwork. In operation 508, the system may determine whether the first metric value satisfies a first predetermined condition. Based on determining that the first metric value does not satisfy the first predetermined condition, in operation 510, the system may determine not to train the obtained first subnetwork for the one-shot NAS and, in operation 512, the system may obtain a second subnetwork of the plurality of candidate subnetworks from the overall network. In operation 514, the system may train the second subnetwork for the one-shot NAS.

The training of the second subnetwork may include obtaining a second metric value of the second subnetwork and determining whether the second metric value satisfies the first predetermined condition, where the second subnetwork for the one-shot NAS is trained based on determining that the second metric value satisfies the first predetermined condition. The determining whether the first metric value satisfies the first predetermined condition may include comparing the first metric value to a first predetermined threshold. The determining whether the first metric value satisfies the first predetermined condition may include determining whether the first metric value is greater than a first predetermined threshold and less than a second predetermined threshold. The obtaining the first metric value comprises may include obtaining a plurality of metric values, including the first metric value of the first subnetwork, and the determining whether the first metric value satisfies a first predetermined condition may include determining whether the plurality of metric values respectively satisfy a corresponding plurality of predetermined conditions, including the first predetermined condition, for training in the one-shot NAS. The first metric value may include at least one of a latency value, a model size value, and a FLOPS value. The first predetermined condition may be determined based on at least one of an overall number of layers in a subnetwork, an overall number of convolutional layers in a subnetwork, an overall number of residual blocks in a subnetwork, and an overall number of transport layers in a subnetwork.

By filtering out impossible or impractical subnetworks in the training stage of the one-shot NAS, potentially detrimental and unnecessary training may be omitted, thereby avoiding redundant training and collapse of shared weights, and expediting the training stage.

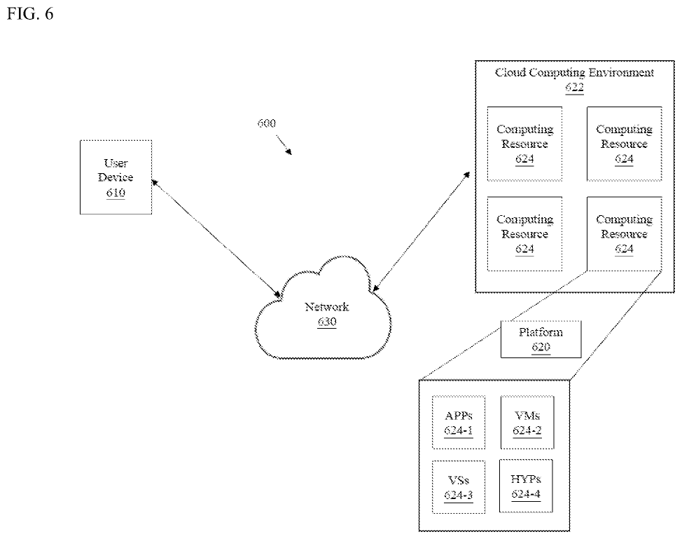

FIG. 6 is a diagram of an example environment 600 in which systems and/or methods, described herein, may be implemented. As shown in FIG. 6, environment 600 may include a user device 610, a platform 620, and a network 630. Devices of environment 600 may interconnect via wired connections, wireless connections, or a combination of wired and wireless connections. In embodiments, any of the functions and operations described with reference to FIG. 1 above may be performed by any combination of elements illustrated in FIG. 6.

User device 610 includes one or more devices capable of receiving, generating, storing, processing, and/or providing information associated with platform 620. For example, user device 610 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 610 may receive information from and/or transmit information to platform 620.

Platform 620 includes one or more devices capable of receiving, generating, storing, processing, and/or providing information. In some implementations, platform 620 may include a cloud server or a group of cloud servers. In some implementations, platform 620 may be designed to be modular such that certain software components may be swapped in or out depending on a particular need. As such, platform 620 may be easily and/or quickly reconfigured for different uses.

In some implementations, as shown, platform 620 may be hosted in cloud computing environment 622. Notably, while implementations described herein describe platform 620 as being hosted in cloud computing environment 622, in some implementations, platform 620 may not be cloud-based (i.e., may be implemented outside of a cloud computing environment) or may be partially cloud-based.

Cloud computing environment 622 includes an environment that hosts platform 620. Cloud computing environment 622 may provide computation, software, data access, storage, etc. services that do not require end-user (e.g., user device 610) knowledge of a physical location and configuration of system(s) and/or device(s) that hosts platform 620. As shown, cloud computing environment 622 may include a group of computing resources 624 (referred to collectively as “computing resources 624” and individually as “computing resource 624”).

Computing resource 624 includes one or more personal computers, a cluster of computing devices, workstation computers, server devices, or other types of computation and/or communication devices. In some implementations, computing resource 624 may host platform 620. The cloud resources may include compute instances executing in computing resource 624, storage devices provided in computing resource 624, data transfer devices provided by computing resource 624, etc. In some implementations, computing resource 624 may communicate with other computing resources 624 via wired connections, wireless connections, or a combination of wired and wireless connections.

As further shown in FIG. 6, computing resource 624 includes a group of cloud resources, such as one or more applications (“APPs”) 624-1, one or more virtual machines (“VMs”) 624-2, virtualized storage (“VSs”) 624-3, one or more hypervisors (“HYPs”) 624-4, or the like.

Application 624-1 includes one or more software applications that may be provided to or accessed by user device 610. Application 624-1 may eliminate a need to install and execute the software applications on user device 610. For example, application 624-1 may include software associated with platform 620 and/or any other software capable of being provided via cloud computing environment 622. In some implementations, one application 624-1 may send/receive information to/from one or more other applications 624-1, via virtual machine 624-2.

Virtual machine 624-2 includes a software implementation of a machine (e.g., a computer) that executes programs like a physical machine. Virtual machine 624-2 may be either a system virtual machine or a process virtual machine, depending upon use and degree of correspondence to any real machine by virtual machine 624-2. A system virtual machine may provide a complete system platform that supports execution of a complete operating system (“OS”). A process virtual machine may execute a single program, and may support a single process. In some implementations, virtual machine 624-2 may execute on behalf of a user (e.g., user device 610), and may manage infrastructure of cloud computing environment 622, such as data management, synchronization, or long-duration data transfers.

Virtualized storage 624-3 includes one or more storage systems and/or one or more devices that use virtualization techniques within the storage systems or devices of computing resource 624. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 624-4 may provide hardware virtualization techniques that allow multiple operating systems (e.g., “guest operating systems”) to execute concurrently on a host computer, such as computing resource 624. Hypervisor 624-4 may present a virtual operating platform to the guest operating systems, and may manage the execution of the guest operating systems. Multiple instances of a variety of operating systems may share virtualized hardware resources.

Network 630 includes one or more wired and/or wireless networks. For example, network 630 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) of environment 600 may perform one or more functions described as being performed by another set of devices of environment 600.

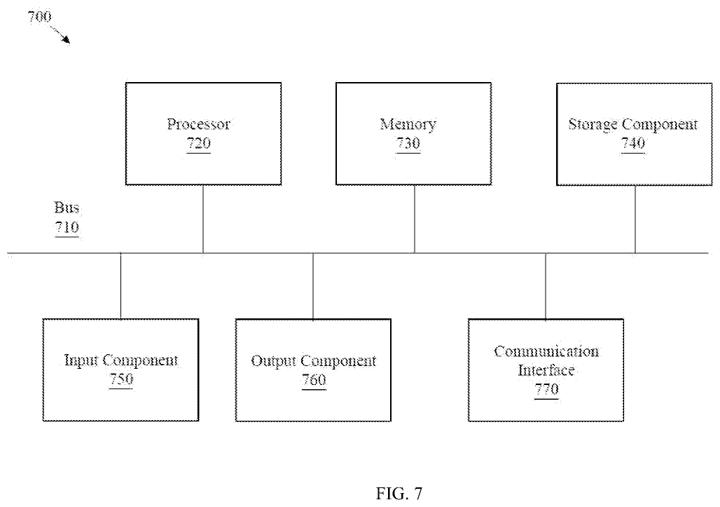

FIG. 7 is a diagram of example components of a device 700. Device 700 may correspond to user device 610 and/or platform 620. As shown in FIG. 7, device 700 may include a bus 710, a processor 720, a memory 730, a storage component 740, an input component 750, an output component 760, and a communication interface 770.

Bus 710 includes a component that permits communication among the components of device 700. Processor 720 may be implemented in hardware, firmware, or a combination of hardware and software. Processor 720 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 720 includes one or more processors capable of being programmed to perform a function. Memory 730 includes a random access memory (RAM), a read only memory (ROM), and/or another type of dynamic or static storage device (e.g., a flash memory, a magnetic memory, and/or an optical memory) that stores information and/or instructions for use by processor 720.

Storage component 740 stores information and/or software related to the operation and use of device 700. For example, storage component 740 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 750 includes a component that permits device 700 to receive information, such as via user input (e.g., a touch screen display, a keyboard, a keypad, a mouse, a button, a switch, and/or a microphone). Additionally, or alternatively, input component 750 may include a sensor for sensing information (e.g., a global positioning system (GPS) component, an accelerometer, a gyroscope, and/or an actuator). Output component 760 includes a component that provides output information from device 700 (e.g., a display, a speaker, and/or one or more light-emitting diodes (LEDs)).

Communication interface 770 includes a transceiver-like component (e.g., a transceiver and/or a separate receiver and transmitter) that enables device 700 to communicate with other devices, such as via a wired connection, a wireless connection, or a combination of wired and wireless connections. Communication interface 770 may permit device 700 to receive information from another device and/or provide information to another device. For example, communication interface 770 may include an Ethernet interface, an optical interface, a coaxial interface, an infrared interface, a radio frequency (RF) interface, a universal serial bus (USB) interface, a Wi-Fi interface, a cellular network interface, or the like.

Device 700 may perform one or more processes described herein. Device 700 may perform these processes in response to processor 720 executing software instructions stored by a non-transitory computer-readable medium, such as memory 730 and/or storage component 740. A computer-readable medium is defined herein as a non-transitory memory device. A memory device includes memory space within a single physical storage device or memory space spread across multiple physical storage devices.

Software instructions may be read into memory 730 and/or storage component 740 from another computer-readable medium or from another device via communication interface 770. When executed, software instructions stored in memory 730 and/or storage component 740 may cause processor 720 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 7 are provided as an example. In practice, device 700 may include additional components, fewer components, different components, or differently arranged components than those shown in FIG. 7. Additionally, or alternatively, a set of components (e.g., one or more components) of device 700 may perform one or more functions described as being performed by another set of components of device 700.

In embodiments, any one of the operations or processes of FIGS. 1-5 may be implemented by or using any one of the elements illustrated in FIGS. 6 and 7.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method for performing a one-shot neural architecture search (NAS), the method comprising:
obtaining an overall network, the overall network comprising a plurality of candidate subnetworks for the one-shot NAS;
obtaining a first subnetwork of the plurality of candidate subnetworks from the overall network;
obtaining a first metric value of the first subnetwork;
determining whether the first metric value satisfies a first predetermined condition;
based on determining that the first metric value does not satisfy the first predetermined condition:
determining not to train the obtained first subnetwork for the one-shot NAS; and
obtaining a second subnetwork of the plurality of candidate subnetworks from the overall network; and
training the second subnetwork for the one-shot NAS.

2. The method of claim 1, wherein the training the second subnetwork comprises:
obtaining a second metric value of the second subnetwork; and
determining whether the second metric value satisfies the first predetermined condition; and
wherein the second subnetwork for the one-shot NAS is trained based on determining that the second metric value satisfies the first predetermined condition.

3. The method of claim 1, wherein the determining whether the first metric value satisfies the first predetermined condition comprises comparing the first metric value to a first predetermined threshold.

4. The method of claim 1, wherein the determining whether the first metric value satisfies the first predetermined condition comprises determining whether the first metric value is greater than a first predetermined threshold and less than a second predetermined threshold.

5. The method of claim 1, wherein the obtaining the first metric value comprises obtaining a plurality of metric values, including the first metric value of the first subnetwork; and
wherein the determining whether the first metric value satisfies the first predetermined condition comprises determining whether the plurality of metric values respectively satisfy a corresponding plurality of predetermined conditions, including the first predetermined condition, for training in the one-shot NAS.

6. The method of claim 1, wherein the first metric value comprises at least one of a latency value, a model size value, and a floating point operations per second (FLOPS) value.

7. The method of claim 1, wherein the first predetermined condition is determined based on at least one of an overall number of layers in a subnetwork, an overall number of convolutional layers in a subnetwork, an overall number of residual blocks in a subnetwork, and an overall number of transport layers in a subnetwork.

8. A system for performing a one-shot neural architecture search (NAS), the system comprising:
at least one memory storing instructions; and
at least one processor configured to execute the instructions to:
obtain an overall network, the overall network comprising a plurality of candidate subnetworks for the one-shot NAS;
obtain a first subnetwork of the plurality of candidate subnetworks from the overall network;
obtain a first metric value of the first subnetwork;
determine whether the first metric value satisfies a first predetermined condition;
based on determining that the first metric value does not satisfy the first predetermined condition:
determine not to train the obtained first subnetwork for the one-shot NAS; and
obtain a second subnetwork of the plurality of candidate subnetworks from the overall network; and
train the second subnetwork for the one-shot NAS.

9. The system of claim 8, wherein the at least one processor is configured to execute the instructions to train the second subnetwork by:
obtaining a second metric value of the second subnetwork; and
determining whether the second metric value satisfies the first predetermined condition; and
wherein the second subnetwork for the one-shot NAS is trained based on determining that the second metric value satisfies the first predetermined condition.

10. The system of claim 8, wherein the at least one processor is configured to execute the instructions to determine whether the first metric value satisfies the first predetermined condition by comparing the first metric value to a first predetermined threshold.

11. The system of claim 8, wherein the at least one processor is configured to execute the instructions to determine whether the first metric value satisfies the first predetermined condition by determining whether the first metric value is greater than a first predetermined threshold and less than a second predetermined threshold.

12. The system of claim 8, wherein the at least one processor is configured to execute the instructions to obtain the first metric value by obtaining a plurality of metric values, including the first metric value of the first subnetwork; and
wherein the at least one processor is configured to execute the instructions to determine whether the first metric value satisfies the first predetermined condition by determining whether the plurality of metric values respectively satisfy a corresponding plurality of predetermined conditions, including the first predetermined condition, for training in the one-shot NAS.

13. The system of claim 8, wherein the first metric value comprises at least one of a latency value, a model size value, and a floating point operations per second (FLOPS) value.

14. The system of claim 8, wherein the first predetermined condition is determined based on at least one of an overall number of layers in a subnetwork, an overall number of convolutional layers in a subnetwork, an overall number of residual blocks in a subnetwork, and an overall number of transport layers in a subnetwork.

15. A non-transitory computer-readable storage medium storing instructions that, when executed by at least one processor, cause the at least one processor to:
obtain an overall network, the overall network comprising a plurality of candidate subnetworks for the one-shot NAS;
obtain a first subnetwork of the plurality of candidate subnetworks from the overall network;
obtain a first metric value of the first subnetwork;
determine whether the first metric value satisfies a first predetermined condition;
based on determining that the first metric value does not satisfy the first predetermined condition:
determine not to train the obtained first subnetwork for the one-shot NAS; and
obtain a second subnetwork of the plurality of candidate subnetworks from the overall network; and
train the second subnetwork for the one-shot NAS.

16. The storage medium of claim 15, wherein the instructions, when executed, cause the at least one processor to train the second subnetwork by:
obtaining a second metric value of the second subnetwork; and
determining whether the second metric value satisfies the first predetermined condition; and
wherein the second subnetwork for the one-shot NAS is trained based on determining that the second metric value satisfies the first predetermined condition.

17. The storage medium of claim 15, wherein the instructions, when executed, cause the at least one processor to determine whether the first metric value satisfies the first predetermined condition by comparing the first metric value to a first predetermined threshold.

18. The storage medium of claim 15, wherein the instructions, when executed, cause the at least one processor to determine whether the first metric value satisfies the first predetermined condition by determining whether the first metric value is greater than a first predetermined threshold and less than a second predetermined threshold.

19. The storage medium of claim 15, wherein the instructions, when executed, cause the at least one processor to obtain the first metric value by obtaining a plurality of metric values, including the first metric value of the first subnetwork; and
wherein the instructions, when executed, cause the at least one processor to determine whether the first metric value satisfies the first predetermined condition by determining whether the plurality of metric values respectively satisfy a corresponding plurality of predetermined conditions, including the first predetermined condition, for training in the one-shot NAS.

20. The storage medium of claim 15, wherein the first metric value comprises at least one of a latency value, a model size value, and a floating point operations per second (FLOPS) value.
